(19) United States
(12) Patent Application Publication
(10) Pub. No.: US 2011/0040958 A1
(43) Pub. Date: Feb. 17, 2011

(54) METHOD OF SWITCHING COMPUTER OPERATING SYSTEMS

(75) Inventors: Giant Liang, Changhua County (TW); Sub Chung, Taichung City (TW); Alex Tang, Changhua County (TW)

Correspondence Address: LAW OFFICES OF MIKIO ISHIMARU, 333 W. EL CAMINO REAL, SUITE 330, SUNNYVALE, CA, 94087, US

(73) Assignee: INSYDE SOFTWARE CORPORATION, Taipei (TW)

(21) Appl. No.: 12/722,442

(22) Filed: Mar. 11, 2010

(30) Foreign Application Priority Data
Aug. 14, 2009 (TW) 098127360

(51) Int. Cl. G06F 15/177; G06F 12/00; G06F 12/02

(52) U.S. Cl. 713/2; 711/170; 711/E12.001; 711/E12.002

(57) ABSTRACT

The present invention relates to a method of switching operating systems in a computer, with which the computer executes the procedure of switching different operating systems. A first operating system executes a process of switching to a second operating system. A process of restoring backup data of a BIOS is executed. The BIOS reads computer system information of an initial state backed up in a memory of the computer and configures the computer to make the computer restored to the initial state of booting. The BIOS calls and executes an interruption service to search a loader of the second operating system. The loader loads the second operating system into the memory. The second operating system boots up and is entered.

### FIELD OF THE INVENTION

The present invention relates to a method of switching operating systems in a computer, and in particular, a method of switching various operating systems in a computer that has two or more operating systems installed.

### BACKGROUND TO THE INVENTION

There is firmware generally known as BIOS (Basic Input Output System) in a computer system. It accompanies a computer machine and is a program stored in a read-only memory (ROM), which comprises many basic subprograms of input/output instructions for the computer. When the computer boots up, a basic input output system will be executed to conduct an initial value configuration and power-on self test (POST), and the data (memory size, whether there are floppy disc drive and hard disc drive, system time, etc.) in the CMOS (Complementary Metal-Oxide Semiconductor) are read.

After the completion of the aforementioned booting process, the computer will load and execute the operating system (OS) and run applications in the operating system environment. In accordance with the demand of computer users, two or more different operating systems rather than a single operating system are desired to be installed in the computer so that the user can perform tasks with the computer.

For a computer having two or more operating systems installed, when the operating environment is to be switched from the current operating system to another one, a shutdown process is usually conducted first and then the computer boots up again. During the booting process, for example, a hotkey should be pressed so that the BIOS loads and executes another operating system.

However, the aforementioned method of switching the operating environment from the current operating system to another one requires shutting down and then re-booting the computer. Such a procedure of shutting down and then re-booting the computer greatly increases the time for the user's waiting for the switch between operating systems and also increases the procedure of the computer executing the switch between operating systems.

### SUMMARY OF THE INVENTION

The object of the present invention is to provide a method of switching operating systems in a computer, with which, when different operating systems in the computer are to be switched, the computer need not execute the procedure of shutdown and re-booting. Therefore, the time for the user's waiting for the switch between operating systems is shortened and the procedure of the computer executing the switch between operating systems is reduced.

According to the first aspect of the present invention, a method of switching operating systems in a computer is provided, with which the computer executes the procedure of switching different operating systems. The method comprises the steps of:

executing a process of switching to a second operating system in a first operating system;

executing a process of restoring backup data of a BIOS;

the BIOS reading a piece of computer system information of an initial state backed up in a memory of the computer and configuring the computer to make the computer restored to the initial state of booting;

the BIOS calling and executing an interruption service to search a loader of the second operating system;

the loader loading the second operating system into the memory; and

booting and entering the second operating system.

According to the second aspect of the present invention, the method of the first aspect further comprises the steps of:

executing the booting process of the BIOS;

the BIOS backing up the piece of computer system information of an initial state in the memory;

the BIOS calling and executing the interruption service to search the loader of the first operating system;

the loader loading the first operating system into the memory; and

booting and entering the first operating system.

According to the third aspect of the present invention, in the method of the second aspect, the piece of computer system information comprises information about a memory type range register (MTRR) of CPU, a BIOS data area (BDA), an extended BIOS area (EBDA), a CMOS, and a low pin count (LPC) register of a south bridge.

According to the fourth aspect of the present invention, in the method of the second aspect, the loader executes the steps of:

sending the BIOS a request for allocation of a memory space, so that the BIOS replies with a starting address of the allocated memory space;

adjusting the address of the program machine code; and

loading the adjusted program machine code into the memory.

According to the fifth aspect of the present invention, a computer readable recording medium having a program recorded thereon is provided. The method as defined in any one of the first to fourth aspects can be implemented when the program is loaded into a computer from the recording medium and executed.

According to the sixth aspect of the present invention, a computer program product having a program recorded therein is provided. The method as defined in any one of the first to fourth aspects can be implemented when the program is loaded into a computer from the computer program product and executed.

### BRIEF DESCRIPTION OF THE DRAWINGS

FIG. 1 is a flowchart of the method of switching operating systems in a computer according to the present invention.

### DESCRIPTION OF PREFERRED EMBODIMENTS

A preferred embodiment of the present invention will be described below with reference to the accompanying drawing.

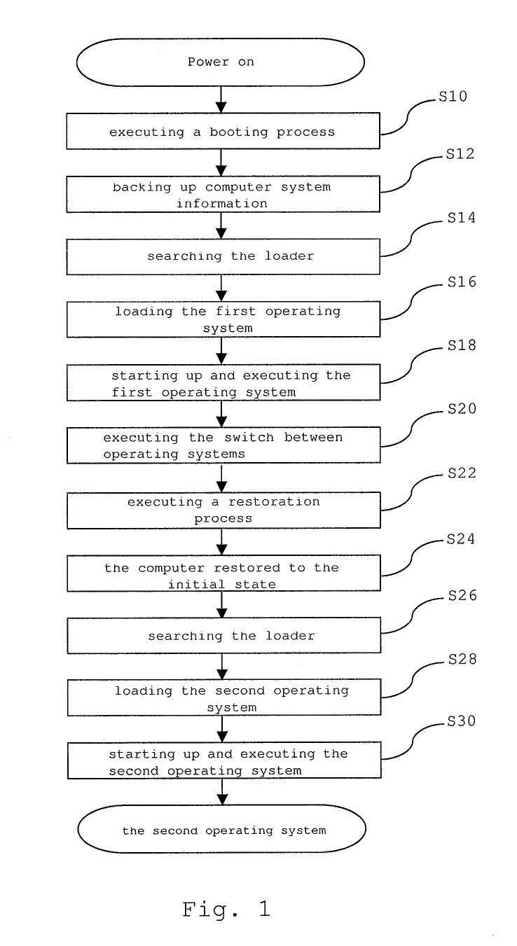

FIG. 1 is a flowchart of the method of switching operating systems in a computer according to the present invention. The procedure shown in FIG. 1 is implemented in accordance with the hardware architecture of a computer. The hardware architecture of a computer described below is well known to the persons having ordinary knowledge in this art and will thus be omitted here.

Referring to FIG. 1, after being powered on, the computer will execute a well-known BIOS booting process (Step S10). During the BIOS booting process, an SMI (System Management Interrupt) signal is triggered to call and execute a first SMI handler function, and this function backs up a piece of important computer system information of initial state in a memory of the computer (Step S12). Here, the piece of computer system information comprises information about a memory type range register (MTRR) of CPU, a BIOS data area (BDA), an extended BIOS area (EBDA), a CMOS, and a low pin count (LPC) register of a south bridge.

Next, during the BIOS booting process, an interruption service program is called and executed to search a loader of the first operating system (Step S14). Here, the loader executes the following steps:
(1) The operating system is stored in the disk drive before booting. When the operating system is to be executed, it is necessary to allocate a block of the memory space so that the operating system can be loaded and executed. When the operating system is to be executed, the loader will send the BIOS a request for allocation of a sufficient block of the memory space. When the space is available, the BIOS will reply to the loader with a starting address of the allocated memory space.
(2) After the BIOS replies with the starting address of the allocated memory space, the loader will adjust the machine code of the operating system in connection with the address so that the operating system can be correctly executed later.
(3) The adjusted machine code of the operating system is loaded into the memory and waits to be executed by the operating system.

Next, the loader loads the first operating system into the memory (Step S16) and then starts up and executes the first operating system to enter the operating environment of the first operating system (Step S18). The user can thus use applications that are compatible with the operating environment of the first operating system.

Under the operating environment of the first operating system, if a switch from the first operating system to the second operating system is to be made, an application for switching operating systems is executed in the first operating system (Step S20). When the application is executed, an SMI signal of the BIOS will be triggered to call and execute a second SMI handler function (Step S22).

When the function is executed, the BIOS reads the piece of computer system information of initial state that has been backed up in the memory, and configures the computer to make the computer restored to the initial state of booting (Step S24).

Next, the BIOS calls and executed the interruption service program to search a loader of the second operating system (Step S26). The loader loads the second operating system into the memory (Step S28) and then starts up and executes the second operating system to enter the operating environment of the second operating system (Step S30). The user can thus use applications that are compatible with the operating environment of the second operating system.

The method of switching operating systems in a computer according to the present invention as described above can be implemented with a program, and the program can be stored in a computer readable recording medium. The procedural steps as described above and shown in the drawing can be implemented when the program is loaded into a computer from the computer readable recording medium and executed.

Similarly, the method of switching operating systems in a computer according to the present invention as described above can be implemented with a computer program product. The procedural steps as described above and shown in the drawing can be implemented when the computer program product is, for example, downloaded to a computer from the internet and executed.

The advantage of the present invention is to provide a method of switching operating systems in a computer, with which, when different operating systems in the computer are to be switched, the computer need not execute the procedure of shutdown and re-booting. Therefore, the time for the user's waiting for the switch between operating systems is shortened and the procedure of the computer executing the switch between operating systems is reduced.

While the present invention has been described above with reference to the preferred embodiment and illustrative drawing, it should not be considered as limited thereby. Various equivalent alterations, omissions and modifications made to its configuration and the embodiment by the skilled persons could be conceived of without departing from the scope of the present invention.

What is claimed is:

1. A method of switching operating systems in a computer, with which the computer executes the procedure of switching different operating systems, the method comprising the steps of:
executing a process of switching to a second operating system in a first operating system;
executing a process of restoring backup data of a BIOS;
the BIOS reading a piece of computer system information of an initial state backed up in a memory of the computer and configuring the computer to make the computer restored to the initial state of booting;
the BIOS calling and executing an interruption service to search a loader of the second operating system;
the loader loading the second operating system into the memory; and
booting and entering the second operating system.

2. The method according to claim 1, further comprising the steps of:
executing the booting process of the BIOS;
the BIOS backing up the piece of computer system information of an initial state in the memory;
the BIOS calling and executing the interruption service to search the loader of the first operating system;
the loader loading the first operating system into the memory; and
booting and entering the first operating system.

3. The method according to claim 2, wherein the piece of computer system information comprises information about a memory type range register of CPU, a BIOS data area, an extended BIOS area, a CMOS, and a low pin count register of a south bridge.

4. The method according to claim 2, wherein the loader executes the steps of:
sending the BIOS a request for allocation of a memory space, so that the BIOS replies with a starting address of the allocated memory space;
adjusting the address of the program machine code; and
loading the adjusted program machine code into the memory.

5. A computer readable recording medium having a program recorded thereon, adapted to implement the method as defined in any one of claims 1 to 4 when the program is loaded into a computer from the recording medium and executed.

6. A computer program product having a program recorded therein, adapted to implement the method as defined in any one of claims 1 to 4 when the program is loaded into a computer from the computer program product and executed.
